(19) United States
(12) Patent Application Publication
(10) Pub. No.: US 2026/0277089 A1
(43) Pub. Date: Sep. 17, 2026

(54) PROJECTION APPARATUS

(71) Applicant: Coretronic Corporation, Hsin-Chu (TW)

(72) Inventors: Chin-Wen HUANG, Hsin-Chu (TW); Chung-An HSIEH, Hsin-Chu (TW)

(73) Assignee: Coretronic Corporation, Hsin-Chu (TW)

(21) Appl. No.: 19/555,895

(22) Filed: Mar. 4, 2026

(30) Foreign Application Priority Data
Mar. 11, 2025 (CN) 2025102821684

(51) Int. Cl. G03B 21/20; G02B 27/14

(52) U.S. Cl. CPC G03B 21/2066; G02B 27/144

(57) ABSTRACT

A projection apparatus includes an illumination module, a first beam splitting film layer, a light valve module, and a lens module. The light valve module receives an illumination beam from the illumination module, and converts it into an image beam. The lens module receives the image beam. The first beam splitting film layer is positioned between the illumination module and the lens module, and reflects a portion of the beam and transmit another portion of the beam. The beam comprises a first beam with a first wavelength range and a second beam with a second wavelength range. A transmittance of the first beam splitting film layer in the first wavelength range is less than that in the second wavelength range, and the light energy of the first beam reflected by the first beam splitting film layer is less than the light energy transmitted through it

### CROSS REFERENCE TO RELATED APPLICATION

This application claims the priority benefit of Chinese Patent Application Serial Number 202510282168.4, filed on March 11, 2025, the full disclosure of which is incorporated herein by reference herein in its entirety.

### BACKGROUND

### Field of the Disclosure

The application relates to the technical field of optics, particularly to a projection apparatus.

### Description of Related Art

In existing laser projection technology, to enhance image resolution, increases the pixel density on the digital micro-mirror device (DMD) to elevate the number of image pixels per unit area under the same projection size.

However, without altering the overall size of the DMD, the size of individual pixels on the DMD must be reduced to increase pixel density. Consequently, when the size of individual pixels matches the wavelength of the three-color light beams of the projector, the diffraction phenomenon of light becomes more pronounced. Additionally, the diffraction behavior varies for light of different wavelengths, thereby affecting the color uniformity of the projected image.

Furthermore, in the design of ultra-short-throw projectors (e.g., those with a throw ratio less than 0.4), the mirror design of the lens restricts the incident angle of the overall optical path. Compared to straight-throw projectors, the optical paths of various color lights typically enter the optical lens at larger angles. The anti-reflection coating (AR Coating) on the optical lens exhibits varying transmittance for light of different polarization directions due to changes in wavelength and incident angle, thereby affecting the intensity distribution of various color lights in the projected image.

Moreover, when implementing high-resolution projection technology, the diffraction effect caused by the unit pixel size, which is close to the wavelength of the beam, occurs during the reflection of the beam incident on the DMD, leading to inconsistent intensity distribution of different color lights in the projected image, thereby resulting in poor color uniformity performance.

Due to the mirror design limitations of the ultra-short-throw lens, which restrict the incident angle of the overall optical path, the three-color light paths enter the optical lens at relatively larger incident angles compared to straight-throw projectors. Furthermore, at large angles, the red light with a longer wavelength is most severely affected when passing through the AR Coating in terms of transmittance, leading to uneven intensity distribution of the three-color beams during projection and resulting in non-uniform color performance distribution.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the projection apparatus of the disclosure comprises an illumination module, a first beam splitting film layer, a light valve module, and a lens module. The illumination module is configured to provide an illumination beam to the light valve module. The light valve module is configured to convert the illumination beam into an image beam. The lens module is configured to receive the image beam. The first beam splitting film layer is positioned in an optical path of a beam between the illumination module and the lens module, and the beam is the illumination beam or the image beam. The beam comprises a first beam having a first wavelength range and a second beam having a second wavelength range, and the first wavelength range is different from the second wavelength range. The first beam splitting film layer is configured to reflect a portion of the beam and transmit another portion of the beam. A transmittance of the first beam splitting film layer in the first wavelength range is less than the transmittance in the second wavelength range, and the light energy of the first beam incident on the first beam splitting film layer that is reflected is less than the light energy transmitted through the first beam splitting film layer.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The disclosure can be more fully understood by reading the subsequent detailed description and examples with references made to the accompanying drawings as follows.

FIG. 1 is a schematic diagram of a projection apparatus according to an embodiment of the disclosure.

FIG. 2 is a schematic diagram of a projection apparatus according to another embodiment of the disclosure.

FIG. 3 is a schematic diagram of a first beam splitting film layer according to an embodiment of the disclosure.

FIG. 4 is a schematic diagram of a first beam splitting film layer according to another embodiment of the disclosure.

FIG. 5 is a schematic diagram of a first beam splitting film layer and a second beam splitting film layer according to yet another embodiment of the disclosure.

FIG. 6 is a front view of a first beam splitting film layer and a second beam splitting film layer according to another embodiment of the disclosure.

FIG. 7 is a rear view of the first beam splitting film layer and the second beam splitting film layer in the embodiment of FIG. 6.

FIG. 8 is a beam schematic corresponding to the embodiment of FIG. 6 and FIG. 7 of the disclosure.

FIG. 9 is a side view schematic of a first beam splitting film layer and a second beam splitting film layer according to an embodiment of the disclosure.

FIG. 10 is a schematic diagram of a first beam splitting film layer and a second beam splitting film layer according to an embodiment of the disclosure.

FIG. 11 is a schematic diagram of a projection apparatus according to an embodiment of the disclosure.

FIG. 12 is a schematic diagram of a projection apparatus according to an embodiment of the disclosure.

FIG. 13 is a schematic diagram of a projection apparatus according to an embodiment of the disclosure.

FIG. 14 is a schematic diagram of a projection apparatus according to an embodiment of the disclosure.

FIG. 15 is a detailed structural schematic of an illumination module according to an embodiment of the disclosure.

FIG. 16, FIG. 17, and FIG. 18 are detailed shape schematics of a first beam splitting film layer according to an embodiment of the disclosure.

FIG. 19, FIG. 20, and FIG. 21 are detailed shape schematics of a second beam splitting film layer according to an embodiment of the disclosure.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

The disclosure provides a projection apparatus that splits a beam of a specified wavelength, allowing a portion of the beam of the specified wavelength to be reflected, thereby enabling a more uniform intensity distribution of each color in the image beam and achieving improved color uniformity of the projected image.

Other objectives and advantages of the disclosure can be further understood from the technical features disclosed in the disclosure. Furthermore, a detailed description is given in the following embodiments with reference to the accompanying drawings.

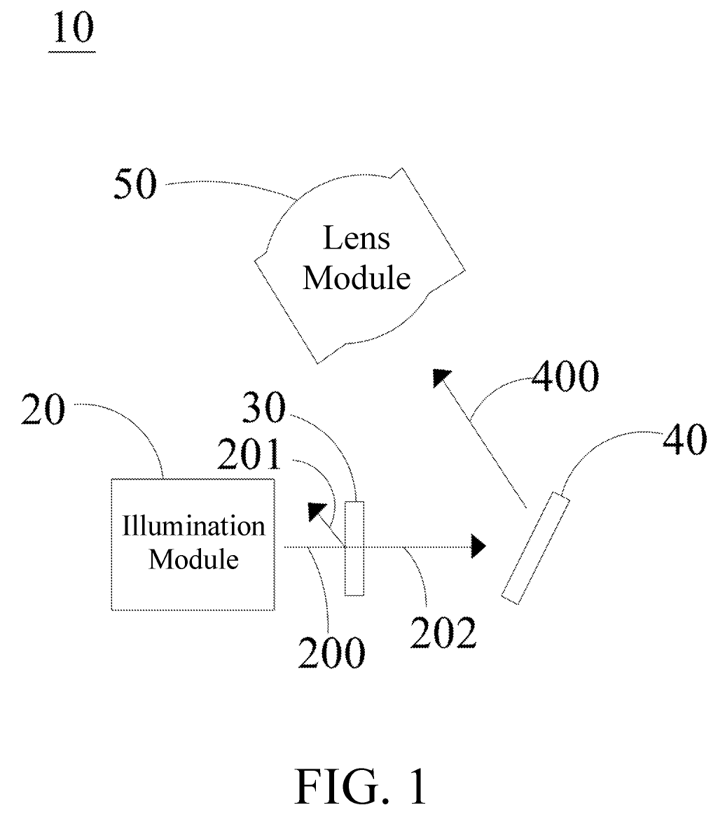

FIG. 1 is a schematic diagram of a projection apparatus according to an embodiment of the disclosure. As shown in FIG. 1, the projection apparatus 10 of the disclosure comprises an illumination module 20, a first beam splitting film layer 30, a light valve module 40, and a lens module 50. The illumination module 20 is configured to provide an illumination beam 200 to the light valve module 40. The light valve module 40 is configured to convert the incident illumination beam 200 into an image beam 400. The lens module 50 is configured to receive the image beam 400. The first beam splitting film layer 30 is positioned in the optical path of a beam between the illumination module 20 and the lens module 50, and the beam is the illumination beam 200 or the image beam 400. The beam comprises a first beam having a first wavelength range and a second beam having a second wavelength range, and the first wavelength range is different from the second wavelength range.

When the first beam splitting film layer 30 receives a beam, the first beam splitting film layer 30 splits the received beam. Specifically, the first beam splitting film layer 30 is configured to reflect a portion of the received beam and transmit another portion of the received beam. A transmittance of the first beam splitting film layer 30 for the first beam in the first wavelength range is less than the transmittance for the second beam in the second wavelength range, and the light energy of the first beam incident on the first beam splitting film layer 30 that is reflected is less than the light energy of the first beam transmitted through the first beam splitting film layer 30.

The projection apparatus 10 may be a projector. The illumination module 20 may, for example, comprise one or more light-emitting elements, and the light-emitting elements may be one or more laser diodes (LDs), one or more light-emitting diodes (LEDs), or a combination of both types of light sources. Specifically, any light source meeting the volume requirements of the actual design can be implemented, and the disclosure is not limited thereto. The light valve module 40 may be a digital micro-mirror device (DMD), a liquid crystal on silicon panel (LCoS panel), or other reflective light modulators, as well as a transparent liquid crystal panel, an electro-optical modulator, a magneto-optic modulator, an acousto-optic modulator (AOM), or other transmissive light modulators. The lens module 50 is configured to project the image beam 400 out of the projection apparatus 10 to a projection target. The projection target may, for example, be a screen or a wall. The lens module 50 may, for example, comprise a combination of one or more optical lenses with diopter, such as various combinations of non-planar lenses including biconcave lenses, biconvex lenses, concave-convex lenses, convex-concave lenses, plano-convex lenses, and plano-concave lenses. In other embodiments, the lens module 50 may also comprise planar optical lenses to project the image beam 400 to the projection target in a reflective manner. The disclosure imposes no restrictions on the type or category of the lens module 50. In this embodiment, the light valve module 40 may be a digital micro-mirror device composed of multiple reflective mirrors, with each reflective mirror having a side length less than 10 micrometers (µm).

Taking the beam as the illumination beam 200 as an example, please refer to FIG. 1. The first beam splitting film layer 30 is located between the illumination module 20 and the light valve module 40, in other words, the first beam splitting film layer 30 is disposed in the optical path transmitting the illumination beam 200, and allows the illumination beam 200 to be incident on the first beam splitting film layer 30. Upon receiving the illumination beam 200, the first beam splitting film layer 30 reflects a portion of the illumination beam 200 to form a reflected beam 201, and the reflected beam 201 does not pass through the first beam splitting film layer 30. Another portion of the illumination beam 200 passes through the first beam splitting film layer 30 to form a transmitted beam 202, which continues to be transmitted to the light valve module 40.

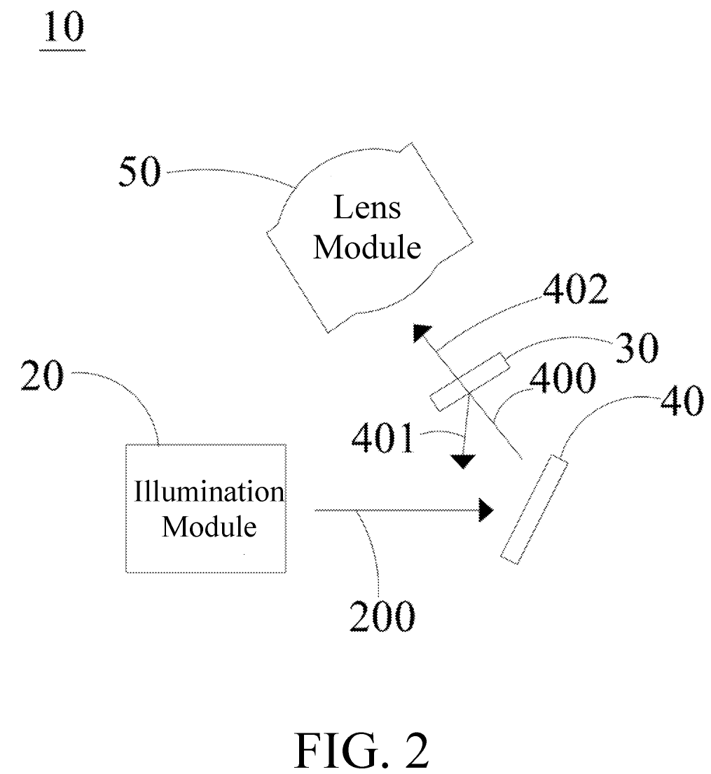

FIG. 2 is a schematic diagram of a projection apparatus according to another embodiment of the disclosure. As shown in FIG. 2, the projection apparatus 10 in this embodiment is substantially the same as the projection apparatus 10 in the embodiment of FIG. 1. The difference lies in that, in this embodiment, the first beam splitting film layer 30 is located between the light valve module 40 and the lens module 50, in other words, the first beam splitting film layer 30 is disposed in the optical path transmitting the image beam 400, and allows the image beam 400 to be incident on the first beam splitting film layer 30. At this point, the beam is the image beam 400. Upon receiving the image beam 400, the first beam splitting film layer 30 reflects a portion of the image beam 400 to form a reflected beam 401, and the reflected beam 401 does not pass through the first beam splitting film layer 30. Another portion of the image beam 400 passes through the first beam splitting film layer 30 to form a transmitted beam 402, which continues to be transmitted to the lens module 50.

As described above, the first beam splitting film layer 30, positioned in the optical path of the beam between the illumination module 20 and the lens module 50, splits the illumination beam or the image beam depending on the placement location. In various placement configurations, the first beam splitting film layer 30 is not disposed on the light incident surface and/or the light exit surface of the light valve module 40.

In one embodiment, the first beam splitting film layer 30 splits the first beam having the first wavelength range and allows the second beam having the second wavelength range to pass through entirely (or with a negligible portion not passing through, wherein the unpenetrated portion may be ignored). The reflected beam 201 (or 401) comprises a portion of the first beam with the first wavelength range, and the transmitted beam 202 (or 402) comprises another portion of the first beam with the first wavelength range and the second beam with the second wavelength range. In one embodiment, the first beam may be the illumination beam or the image beam, and the second beam may be the illumination beam or the image beam. The first beam splitting film layer 30 splits the first beam in the illumination beam or the image beam depending on the placement location.

In one embodiment, the first beam having the first wavelength range and the second beam having the second wavelength range may be transmitted simultaneously. In other words, the illumination module 20 emits the first beam with the first wavelength range and the second beam with the second wavelength range at the same time. In another embodiment, the first beam having the first wavelength range and the second beam having the second wavelength range may be transmitted in a time-division manner; specifically, at a first time point, the illumination module 20 first emits the first beam with the first wavelength range, and at a second time point, the illumination module 20 emits the second beam with the second wavelength range. The first time point and the second time point are different time intervals.

In one embodiment, the first beam is a beam with any wavelength value between 620 nanometers (nm) and 660 nm, that is, the first wavelength range is between 620 nm and 660 nm. The second beam is a beam with any wavelength value between 440 nm and 540 nm, that is, the second wavelength range is between 440 nm and 540 nm. Specifically, when the first beam is red light, the first wavelength range of the first beam is a wavelength value between 620 nm and 660 nm; when the second beam is blue light, the second wavelength range of the second beam is a wavelength value between 440 nm and 480 nm; alternatively, when the second beam is green light, the second wavelength range of the second beam is a wavelength value between 500 nm and 540 nm; or, when the second beam is blue light and green light (i.e., blue-green light), the second wavelength range of the second beam is a wavelength value between 440 nm and 540 nm.

In another embodiment, the first beam is a beam with any wavelength value between 440 nm and 540 nm, that is, the first wavelength range is between 440 nm and 540 nm. The second beam may be a beam with any wavelength value between 620 nm and 660 nm, that is, the second wavelength range is between 620 nm and 660 nm. Specifically, when the first beam is blue light, the first wavelength range of the first beam is a wavelength value between 440 nm and 480 nm; alternatively, when the first beam is green light, the first wavelength range of the first beam is a wavelength value between 500 nm and 540 nm; or, when the first beam is blue light and green light, the first wavelength range of the first beam is a wavelength value between 440 nm and 540 nm. When the second beam is red light, the second wavelength range of the second beam is a wavelength value between 620 nm and 660 nm.

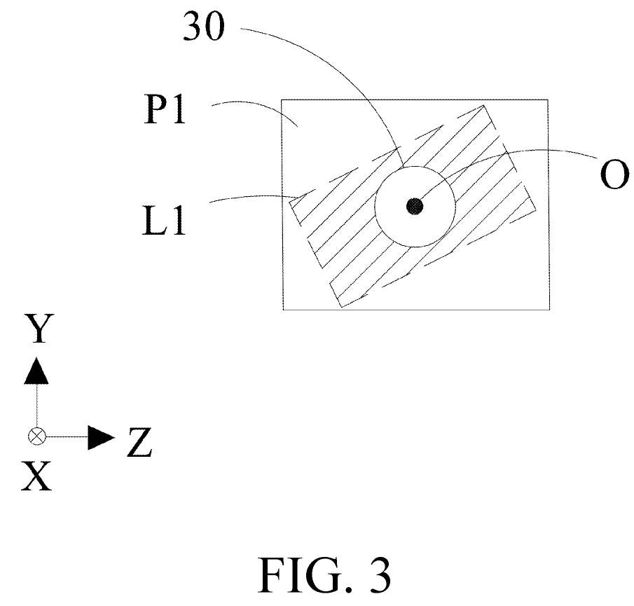

FIG. 3 is a schematic diagram of a first beam splitting film layer according to an embodiment of the disclosure. Referring to FIG. 3, the direction in which the beam is incident on the first beam splitting film layer 30 is defined as the first axial direction X, and the second axial direction Y and the third axial direction Z both are perpendicular to the first axial direction X. When the beam is incident on the first beam splitting film layer 30 along the first axial direction X, a surface perpendicular to the central optical axis O of the beam is defined as the first reference plane P1 (i.e., the plane formed by the second axial direction Y and the third axial direction Z). The beam forms a first light spot L1 on the first reference plane P1, and the orthographic projection of the first beam splitting film layer 30 on the first reference plane P1 at least partially overlaps with the orthographic projection of the first light spot L1 on the first reference plane P1 to form an overlapping region. The area of the orthographic projection of the first light spot L1 on the first reference plane P1 is greater than or equal to the overlapping region. It should be noted that the central optical axis O of the beam in FIG. 3 is not used to represent the irradiation range of the beam incident on the first beam splitting film layer 30 along the first axial direction X. The irradiation range of the beam encompasses the first beam splitting film layer 30 and the hatched area marked in FIG. 3, which corresponds to the region of the first light spot L1.

As shown in FIG. 3, the first beam splitting film layer 30 is disposed on the central optical axis O of the beam (i.e., the central optical axis O of the beam passes through the first beam splitting film layer 30). When the first beam in the beam is incident on the first beam splitting film layer 30 along the first axial direction X, a portion of the first beam is reflected by the first beam splitting film layer 30, and another portion of the first beam passes through the first beam splitting film layer 30. When the second beam in the beam is incident on the first beam splitting film layer 30 along the first axial direction X, the second beam passes through the first beam splitting film layer 30. Specifically, when the beam is incident on the first beam splitting film layer 30, the irradiation range of the beam is greater than or equal to the area of the first beam splitting film layer 30. Within this irradiation range, only the first beam in the beam incident on the first beam splitting film layer 30 is split, while the first beam in the beam incident on the area outside the first beam splitting film layer 30 (such as the hatched area in FIG. 3) passes through; for the second beam, whether incident on the first beam splitting film layer 30 or the hatched area, the second beam passes through. In this embodiment, the first beam is red light, and the second beam is blue light and/or green light. In this embodiment, the transmittance of the first beam splitting film layer 30 in the first wavelength range may be 80% to 99%. In other words, when the first beam splitting film layer 30 is used to split red light, the light intensity of the red light beam passing through the first beam splitting film layer 30 is reduced by 1% to 20% lumens (lm). For example, when the transmittance of the first beam splitting film layer 30 for the red light beam is 80%, the red light beam passing through the first beam splitting film layer 30 is reduced by 20% lumens, with the reduced 20% lumens is reflected by the first beam splitting film layer 30. This ensures that the light energy of the first beam incident on the first beam splitting film layer 30 that is reflected is less than the light energy transmitted through, and allows a slight suppression of the red light intensity near the central optical axis O of the beam. Furthermore, since the transmittance of the first beam splitting film layer 30 in the first wavelength range is less than the transmittance in the second wavelength range, the suppression effect of the first beam splitting film layer 30 on the second beam is less than on the first beam. Thus, by disposing the first beam splitting film layer 30, the red light intensity near the central optical axis O of the beam may be suppressed in cases where red light is concentrated at the center of the projected image, thereby solving the problem of color unevenness in the projected image.

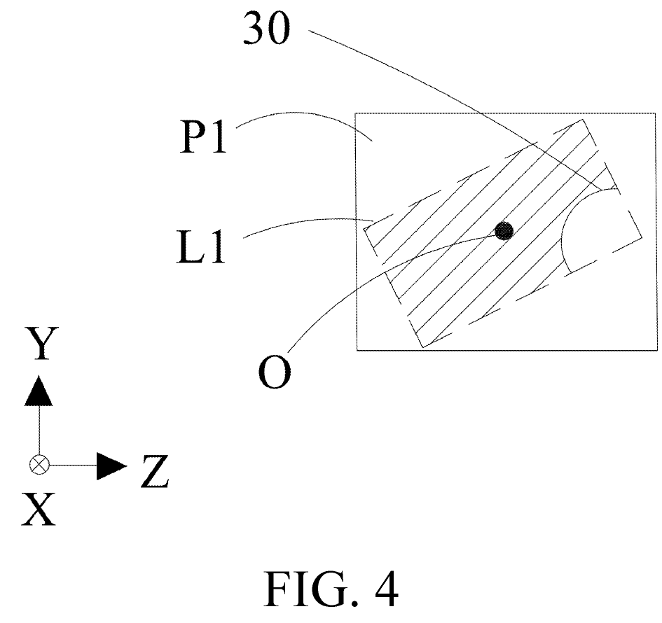

FIG. 4 is a schematic diagram of a first beam splitting film layer according to another embodiment of the disclosure. Unlike FIG. 3, in this embodiment, as shown in FIG. 4, the first beam splitting film layer 30 is not disposed on the central optical axis O of the beam (i.e., the central optical axis O of the beam does not pass through the first beam splitting film layer 30). When the first beam in the beam is incident on the first beam splitting film layer 30 along the first axial direction X, a portion of the first beam is reflected by the first beam splitting film layer 30, and another portion of the first beam passes through the first beam splitting film layer 30. When the second beam in the beam is incident on the first beam splitting film layer 30 along the first axial direction X, the second beam passes through the first beam splitting film layer 30. In this embodiment, the first beam is blue light and/or green light, and the second beam is red light. In this embodiment, the orthographic projection of the first beam splitting film layer 30 on the first reference plane P1 overlaps only with the edge region of the first light spot L1. In this embodiment, the transmittance of the first beam splitting film layer 30 in the first wavelength range may be 80% to 99%. In other words, when the first beam splitting film layer 30 is used to split green light, blue light, or blue-green light, the light intensity of the green light, blue light, or blue-green light beam passing through the first beam splitting film layer 30 is reduced by 1% to 20% lumens (lm), so that the light energy of the first beam incident on the first beam splitting film layer 30 that is reflected is less than the light energy transmitted through the first beam splitting film layer 30, and allows a slight suppression of the blue light and/or green light intensity in the edge region of the beam. Furthermore, since the transmittance of the first beam splitting film layer 30 in the first wavelength range is less than the transmittance in the second wavelength range, the suppression effect of the first beam splitting film layer 30 on the second beam is less than on the first beam. Thus, by disposing the first beam splitting film layer 30, the distribution of blue light and/or green light in the edge region of the projected image can be altered, thereby solving the problem of color unevenness in the projected image.

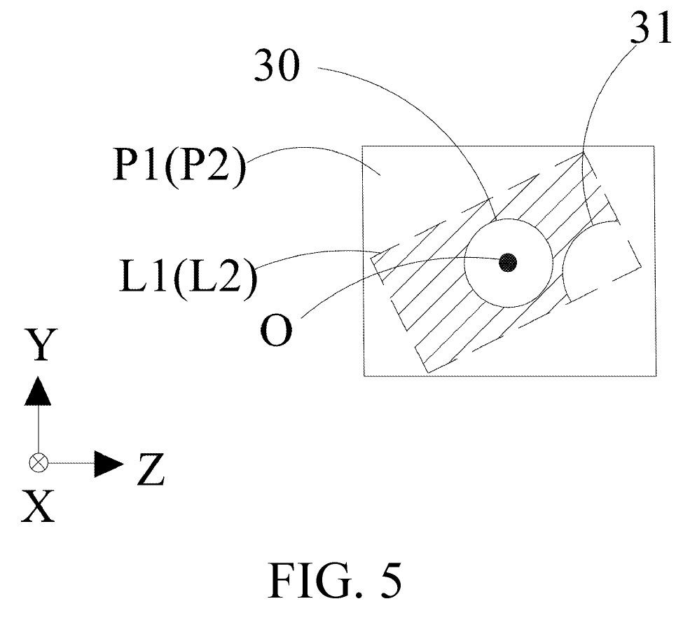

FIG. 5 is a schematic diagram of a first beam splitting film layer and a second beam splitting film layer according to an embodiment of the disclosure. Unlike FIG. 3, in this embodiment, as shown in FIG. 5, the projection apparatus 10, in addition to the first beam splitting film layer 30, further comprises a second beam splitting film layer 31. The first beam splitting film layer 30 in FIG. 3 is similar to the first beam splitting film layer 30 in FIG. 5, and further details are omitted. In this embodiment, the irradiation range of the beam encompasses the first beam splitting film layer 30, the second beam splitting film layer 31, and the hatched area marked in FIG. 5, which corresponds to the region of the first light spot L1. The transmittance of the second beam splitting film layer 31 in the second wavelength range is less than the transmittance in the first wavelength range, and the light energy of the second beam incident on the second beam splitting film layer 31 that is reflected is less than the light energy transmitted through the second beam splitting film layer 31.

When the beam is incident on the second beam splitting film layer 31 along the first axial direction X, a surface perpendicular to the central optical axis O of the beam is defined as a second reference plane P2. The beam forms a second light spot L2 on the second reference plane P2, and the orthographic projection of the second beam splitting film layer 31 on the second reference plane P2 at least partially overlaps with the orthographic projection of the second light spot L2 on the second reference plane P2. The first beam splitting film layer 30 is disposed on the central optical axis O of the beam, while the second beam splitting film layer 31 is not disposed on the central optical axis O of the beam. The orthographic projection of the second beam splitting film layer 31 on the second reference plane P2 overlaps only with the edge region of the second light spot L2. In this embodiment, both the first beam splitting film layer 30 and the second beam splitting film layer 31 are disposed on the same plane, so the first reference plane P1 and the second reference plane P2 are coplanar, and the first light spot L1 and the second light spot L2 are identical. However, in other embodiments, the first beam splitting film layer 30 and the second beam splitting film layer 31 may be disposed on different planes. In various placement configurations, neither the first beam splitting film layer 30 nor the second beam splitting film layer 31 is disposed on the light incident surface and/or the light exit surface of the light valve module 40.

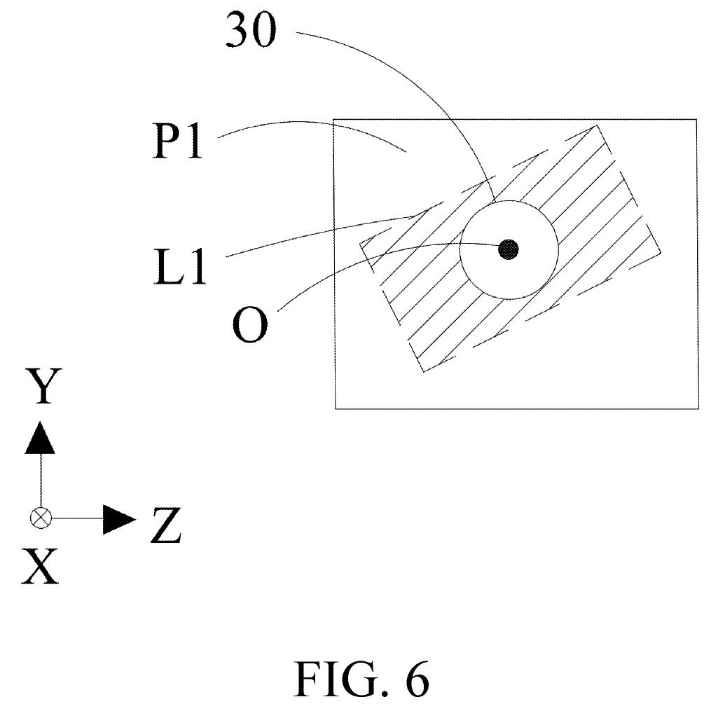

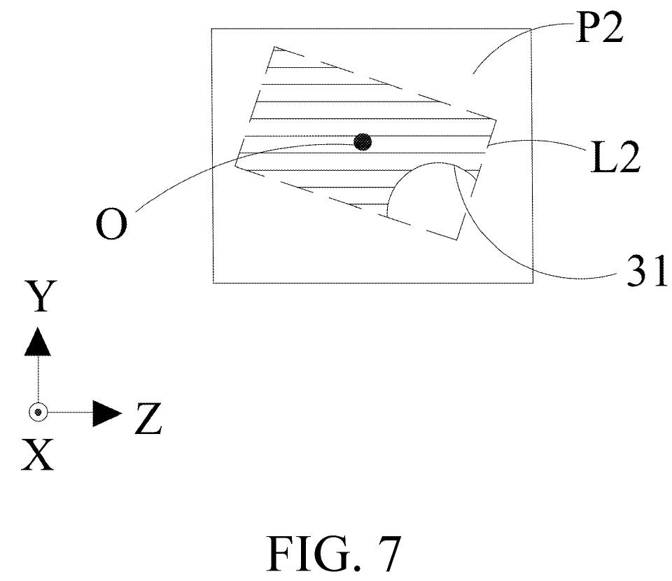

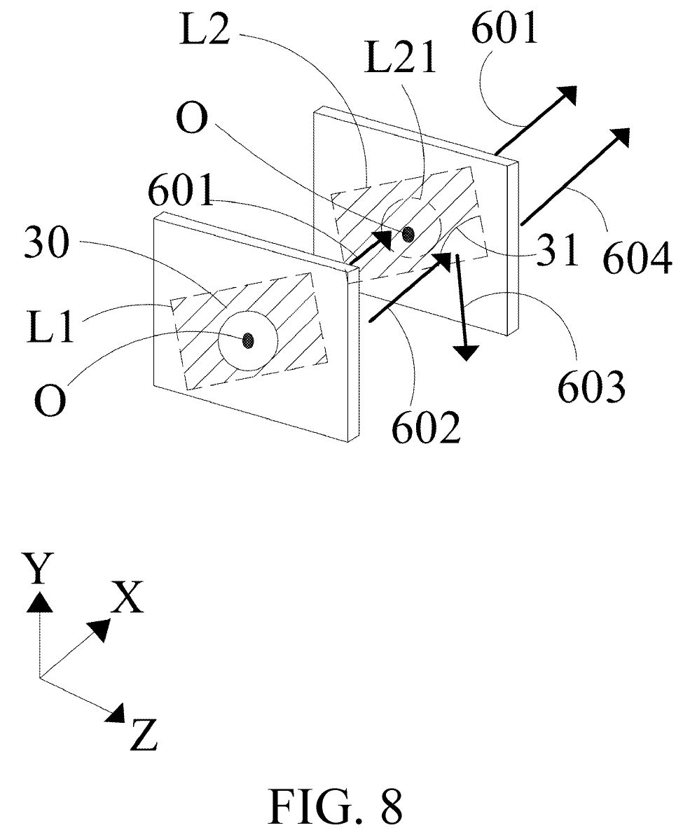

FIG. 6 is a front view of a first beam splitting film layer and a second beam splitting film layer according to another embodiment of the disclosure. FIG. 7 is a rear view of the first beam splitting film layer and the second beam splitting film layer in the embodiment of FIG. 6. FIG. 8 is a beam schematic corresponding to the embodiment of FIG. 6 and FIG. 7 of the disclosure. In this embodiment, as shown in FIG. 6 to FIG. 8, the first beam splitting film layer 30 and the second beam splitting film layer 31 are disposed on different planes. Specifically, in FIG. 6, the beam is incident on the plane where the first beam splitting film layer 30 is located along the first axial direction X. In FIG. 7, the beam is emitted from the plane where the second beam splitting film layer 31 is located along the first axial direction X. As shown in FIG. 8, to more clearly illustrate the changes of the beam passing through the first reference plane P1 and the second reference plane P2, a distance is maintained between the first reference plane P1 and the second reference plane P2; the aforementioned distance does not represent the actual setup scenario. Furthermore, it is understood that when the aforementioned distance is 0, the configuration of the first beam splitting film layer 30 and the second beam splitting film layer 31 is equivalent to the embodiment in FIG. 5. In one embodiment, the second beam splitting film layer 31 splits the second beam having the second wavelength range and allows the first beam having the first wavelength range to pass through entirely (or with a negligible portion not passing through, wherein the unpenetrated portion may be ignored). When the beam is incident on the plane where the first beam splitting film layer 30 is located along the first axial direction X, a portion of the first beam incident on the first beam splitting film layer 30 is reflected, and another portion of the first beam incident on the first beam splitting film layer 30 passes through the first beam splitting film layer 30; when the second beam in the beam is incident on the first beam splitting film layer 30 along the first axial direction X, the second beam passes through the first beam splitting film layer 30 entirely. The second beam passing through the first beam splitting film layer 30 and the another portion of the first beam passing through the first beam splitting film layer 30 form a first transmitted beam 601. The beam incident on the hatched area (refer to FIG. 6) passes through the plane where the first beam splitting film layer 30 is located entirely, forming a second transmitted beam 602. The first transmitted beam 601 and the second transmitted beam 602 continue to be incident on the plane where the second beam splitting film layer 31 is located along the first axial direction X. At this point, no beam splitting film layer is disposed at the position corresponding to the light spot L21 formed by the first transmitted beam 601 on the second reference plane P2, and the first transmitted beam 601 passes through the plane where the second beam splitting film layer 31 is located entirely. For the second transmitted beam 602, a portion of the second beam incident on the second beam splitting film layer 31 is reflected to form a first reflected beam 603, another portion of the second beam incident on the second beam splitting film layer 31 passes through the second beam splitting film layer 31, and the first beam incident on the second beam splitting film layer 31 passes through the second beam splitting film layer 31 entirely. The first beam passing through the second beam splitting film layer 31 and the another portion of the second beam passing through the second beam splitting film layer 31 form a third transmitted beam 604. Additionally, the beam in the second transmitted beam 602 not incident on the second beam splitting film layer 31 also passes through the plane where the second beam splitting film layer 31 is located.

In this embodiment, the first beam is red light, and the second beam is blue light and/or green light. The first beam splitting film layer 30 is disposed on the central optical axis O of the beam and suppresses the red light intensity near the central optical axis O of the beam. The second beam splitting film layer 31 is not disposed on the central optical axis O of the beam and suppresses the distribution of blue light and/or green light in the edge region of the projected image. Thus, by the first beam splitting film layer 30 and the second beam splitting film layer 31 respectively suppressing different wavelength ranges, the color uniformity across various regions of the projected image is improved.

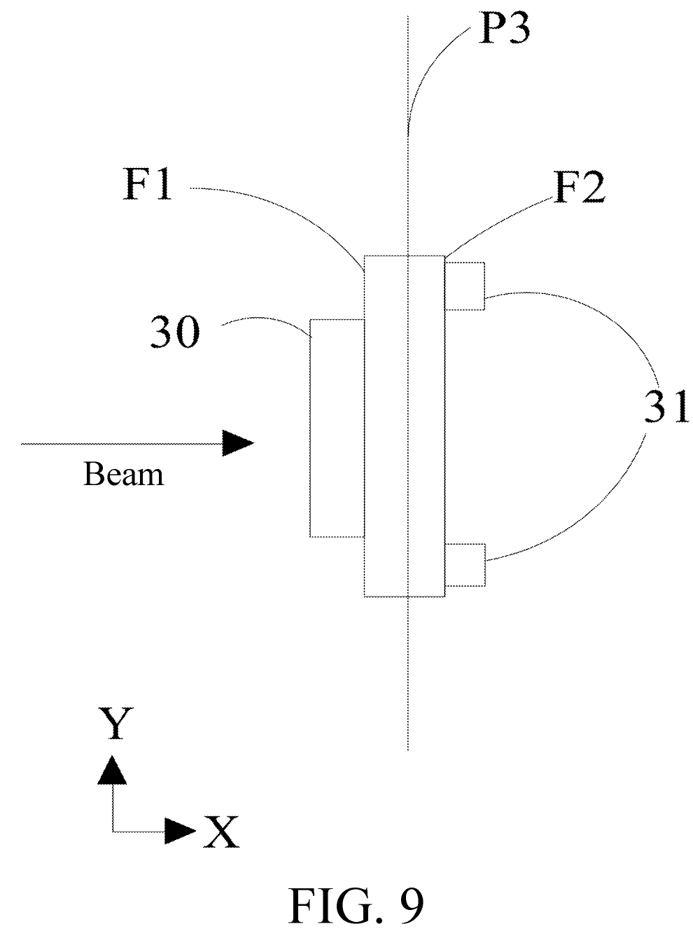

FIG. 9 is a side view schematic of a first beam splitting film layer and a second beam splitting film layer according to an embodiment of the disclosure. In one embodiment, as shown in FIG. 9, the beam is incident on the first beam splitting film layer 30 and the second beam splitting film layer 31 along the first direction X. The first beam splitting film layer 30 is disposed on a first surface F1, with the quantity of the first beam splitting film layer 30 is one, and the second beam splitting film layer 31 is disposed on a second surface F2, with the quantity of the second beam splitting film layer 31 is multiple. The first surface F1 is parallel to the second surface F2, and a third reference plane P3 is defined as parallel to the first surface F1 and the second surface F2, with the third reference plane P3 located, for example, between the first surface F1 and the second surface F2. The orthographic projections of the multiple second beam splitting film layers 31 on the third reference plane P3 surround the orthographic projection of the first beam splitting film layer 30 on the third reference plane P3. In other words, the first surface F1 and the second surface F2 may be the opposing surfaces of the same element (such as a substrate), making the first surface F1 and the second surface F2 parallel and not on the same plane. In one embodiment, the aforementioned first surface F1, second surface F2, and third reference plane P3 may also be the same plane, meaning the first beam splitting film layer 30 and the second beam splitting film layer 31 are disposed on the same surface of the same element.

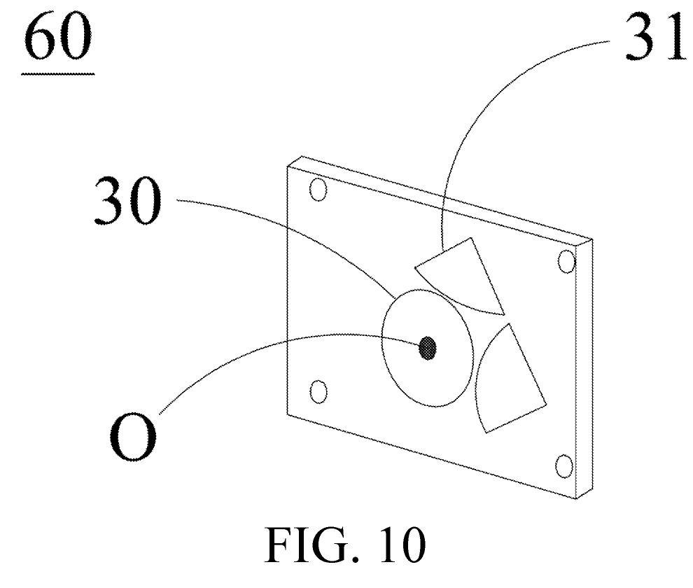

FIG. 10 is a schematic diagram of a first beam splitting film layer and a second beam splitting film layer according to an embodiment of the disclosure. In one embodiment, as shown in FIG. 10, the projection apparatus 10 further comprises a transparent substrate 60. The first beam splitting film layer 30 and the second beam splitting film layer 31 are formed on the transparent substrate 60, and the transparent substrate 60 is positioned between the illumination module 20 and the light valve module 40, or the transparent substrate 60 is positioned between the light valve module 40 and the lens module 50.

In detail, the disclosure utilizes inorganic coating technology to fabricate the first beam splitting film layer 30 and the second beam splitting film layer 31 on the transparent substrate 60. The constituent materials of the first beam splitting film layer 30 and the second beam splitting film layer 31 may be inorganic materials formed by alternating layers of high and low refractive indices, such as silicon dioxide (SiO₂), titanium dioxide (TiO₂), tantalum pentoxide (Ta₂O₅), antimony trioxide (Sb₂O₃), and the like. Furthermore, by different thickness designs, varying transmittances are tailored for beams in specific wavelength ranges (such as the wavelength range of red light, green light, blue light, or blue-green light), thereby adjusting the light intensity of beams in specific wavelength ranges and solving the problem of color unevenness in the projected image. Additionally, in one embodiment, the thickness of the beam splitting film layer is proportional to the wavelength range to be suppressed. Specifically, the thickness of the first beam splitting film layer 30, designed to suppress red light intensity, is greater than the thickness of the second beam splitting film layer 31, designed to suppress blue light and/or green light. In one embodiment, the thicknesses of both the first beam splitting film layer 30 and the second beam splitting film layer 31 are less than 1 micrometer.

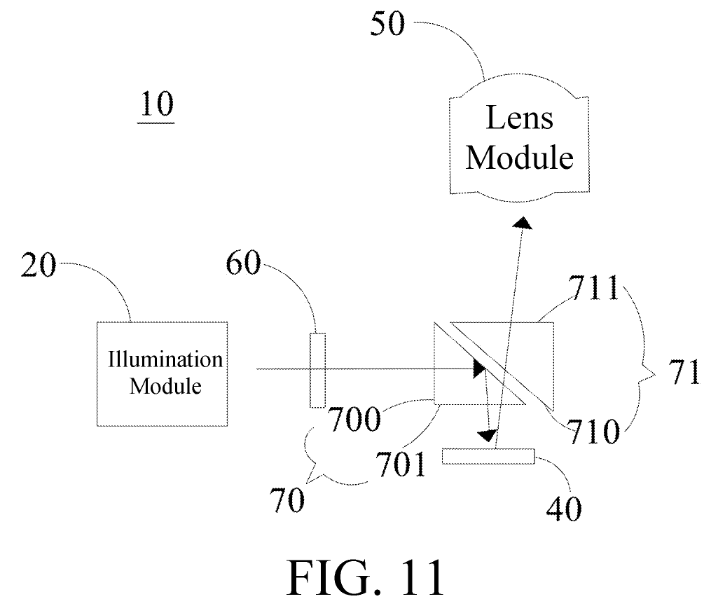

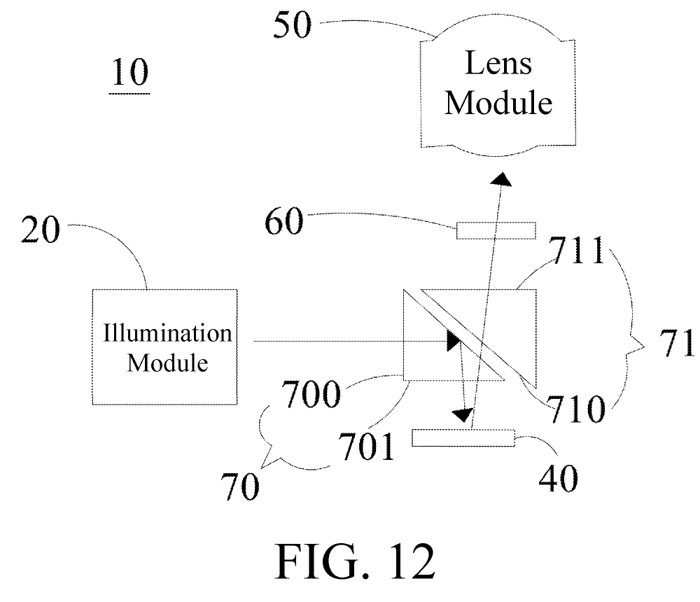

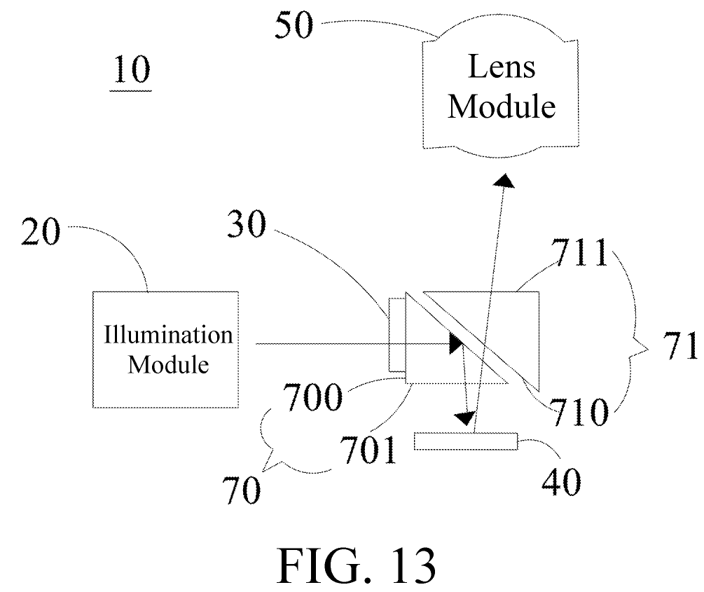

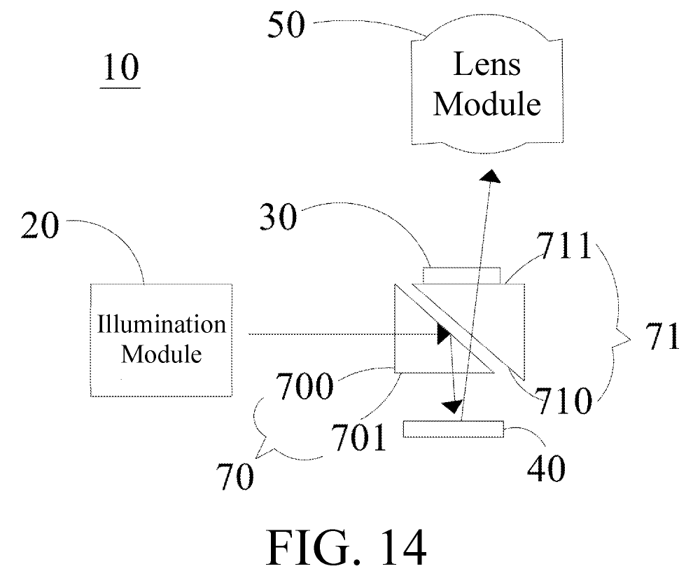

FIG. 11 is a schematic diagram of a projection apparatus according to an embodiment of the disclosure. FIG. 12 is a schematic diagram of a projection apparatus according to an embodiment of the disclosure. FIG. 13 is a schematic diagram of a projection apparatus according to an embodiment of the disclosure. FIG. 14 is a schematic diagram of a projection apparatus according to an embodiment of the disclosure. As shown in FIG. 11, FIG. 12, FIG. 13, and FIG. 14, the projection apparatus 10 further comprises a first prism 70 and a second prism 71. The first prism 70 comprises a first prism light incident surface 700 and a first prism light exit surface 701, the first prism light incident surface 700 receives the illumination beam 200, and the illumination beam 200 is guided by the first prism 70 to the first prism light exit surface 701, the illumination beam 200 is emitted from the first prism light exit surface 701 to the light valve module 40. The second prism 71 comprises a second prism light incident surface 710 and a second prism light exit surface 711, the second prism light incident surface 710 receives the image beam 400 from the light valve module 40, and the image beam 400 is guided by the second prism 71 to the second prism light exit surface 711, the image beam 400 is emitted from the second prism light exit surface 711 to the lens module 50.

In detail, as shown in FIG. 10 and FIG. 11, the first beam splitting film layer 30 and/or the second beam splitting film layer 31 may be formed on the transparent substrate 60. The transparent substrate 60 is positioned between the illumination module 20 and the first prism light incident surface 700, and allows the illumination beam 200 to first undergo beam splitting by the first beam splitting film layer 30 and/or the second beam splitting film layer 31 on the transparent substrate 60 before being transmitted to the first prism 70.

In one embodiment, as shown in FIG. 10 and FIG. 12, the first beam splitting film layer 30 and/or the second beam splitting film layer 31 are formed on the transparent substrate 60. The transparent substrate 60 is positioned between the second prism light exit surface 711 and the lens module 50, and allows the illumination beam 200 to first be converted into the image beam 400 by the light valve module 40, and then the image beam 400 undergoes beam splitting by the first beam splitting film layer 30 and/or the second beam splitting film layer 31 on the transparent substrate 60.

In one embodiment, as shown in FIG. 13, the first beam splitting film layer 30 and/or the second beam splitting film layer 31 (not shown in the figure) are formed on the first prism light incident surface 700. In another embodiment, as shown in FIG. 14, the first beam splitting film layer 30 and/or the second beam splitting film layer 31 are formed on the second prism light exit surface 711. In one embodiment, the first beam splitting film layer 30 is formed on the first prism light incident surface 700 or the second prism light exit surface 711. In another embodiment, the second beam splitting film layer 31 is formed on the first prism light incident surface 700 or the second prism light exit surface 711.

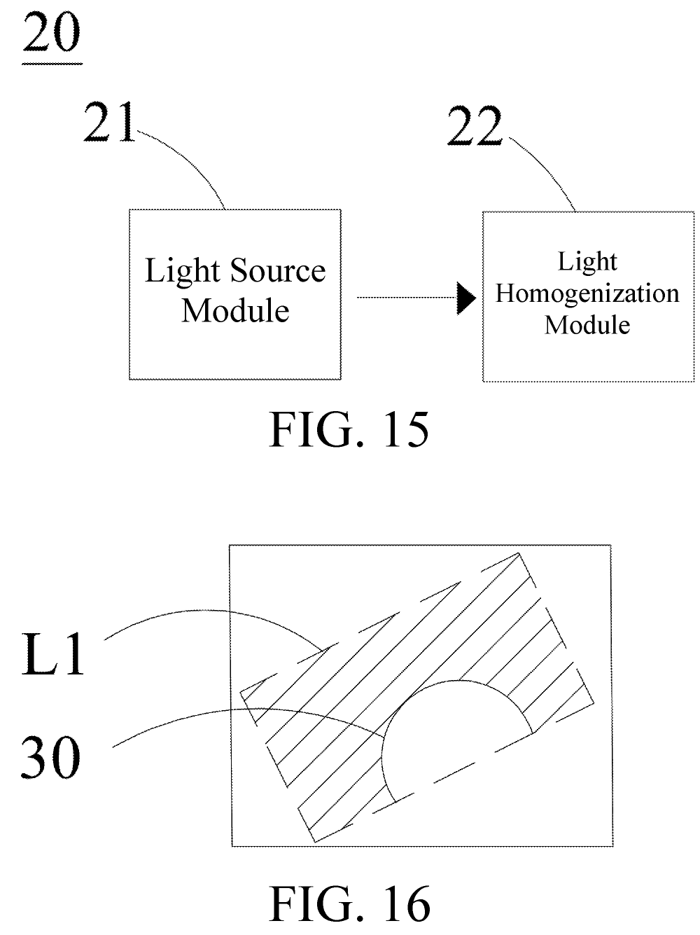

FIG. 15 is a detailed structural schematic of an illumination module according to an embodiment of the disclosure. In one embodiment, as shown in FIG. 15, the illumination module 20 comprises a light source module 21 and a light homogenization module 22. The light source module 21 is configured to provide a light source beam. The light homogenization module 22 is disposed in the optical path of the light source beam, and the light homogenization module 22 is configured to homogenize the light source beam to form the illumination beam 200. In this embodiment, the light source module 21 may be a laser light source.

To better understand the shape variations of the first beam splitting film layer 30 and the second beam splitting film layer 31 of the disclosure, several different shape variations are described below.

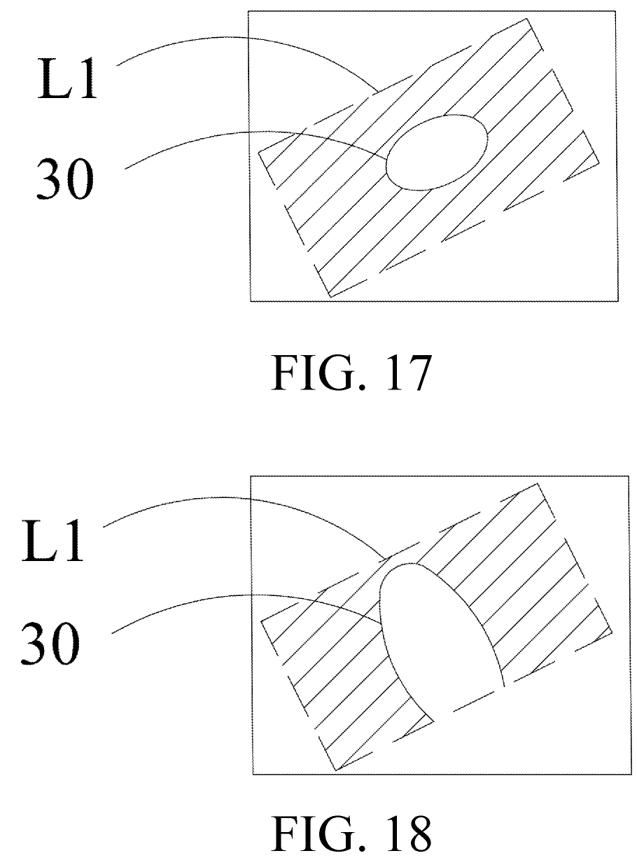

FIG. 16, FIG. 17, and FIG. 18 are detailed shape schematics of a first beam splitting film layer according to an embodiment of the disclosure. As shown in FIG. 16, FIG. 17, and FIG. 18, the first beam splitting film layer 30 may have an incomplete circular shape, an elliptical shape, an incomplete elliptical shape, or any arbitrary shape, applicable in embodiments where the first beam splitting film layer 30 is disposed on the central optical axis O of the beam.

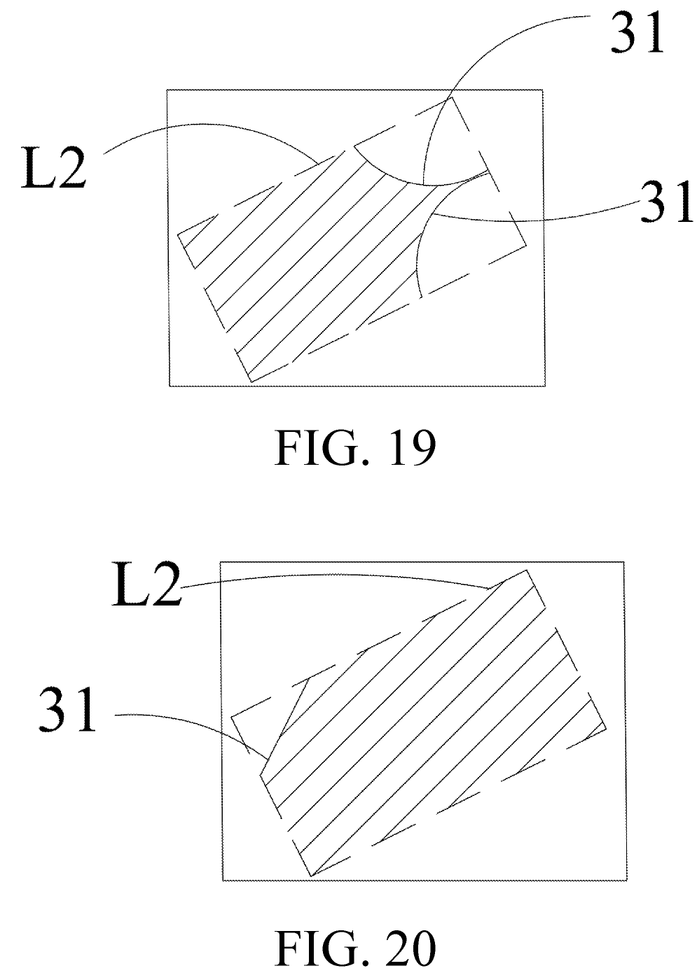

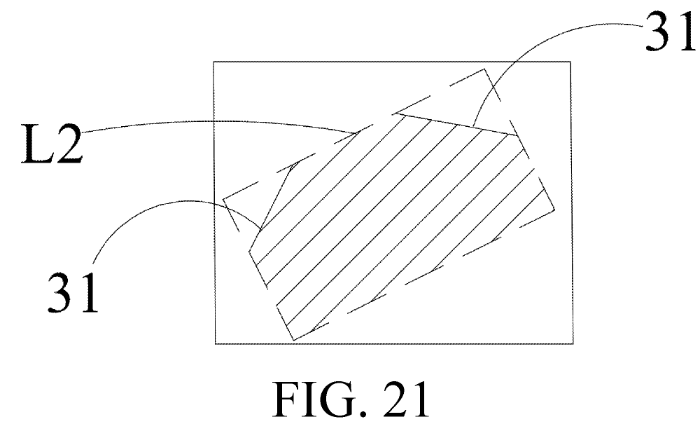

FIG. 19, FIG. 20, and FIG. 21 are detailed shape schematics of a second beam splitting film layer according to an embodiment of the disclosure. As shown in FIG. 19, FIG. 20, and FIG. 21, the second beam splitting film layer 31 may have a sector shape, a triangular shape, a shape composed of multiple sectors, a shape composed of multiple triangles, or any arbitrary shape. Additionally, the second beam splitting film layer 31 may be applied in embodiments where the first beam splitting film layer 30 is not disposed on the central optical axis O of the beam.

In summary, by disposing the first beam splitting film layer in the optical path of the beam, a portion of the beam is reflected by the first beam splitting film layer while another portion of the beam passes through the first beam splitting film layer, and ensures that not all of the light energy in a specific wavelength range of the beam is transmitted to the lens module, thereby makes the intensity distribution of each color in the image beam more uniform and improves the color uniformity of the projected image.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising: an illumination module, a first beam splitting film layer, a light valve module, and a lens module, wherein:
the illumination module is configured to provide an illumination beam to the light valve module;
the light valve module is configured to convert the illumination beam into an image beam; and
the lens module is configured to receive the image beam; wherein:
the first beam splitting film layer is positioned in an optical path of a beam between the illumination module and the lens module, and the beam is the illumination beam or the image beam;
the beam comprises a first beam having a first wavelength range and a second beam having a second wavelength range;
the first wavelength range is different from the second wavelength range;
the first beam splitting film layer is configured to reflect a portion of the beam and transmit another portion of the beam, wherein a transmittance of the first beam splitting film layer in the first wavelength range is less than the transmittance in the second wavelength range; and
light energy of the first beam incident on the first beam splitting film layer that is reflected is less than light energy transmitted through the first beam splitting film layer.

2. The projection apparatus according to claim 1, wherein when the beam is incident on the first beam splitting film layer, a surface perpendicular to the central optical axis of the beam is defined as a first reference plane, the beam forms a first light spot on the first reference plane, and an orthographic projection of the first beam splitting film layer on the first reference plane at least partially overlaps with the first light spot.

3. The projection apparatus according to claim 2, wherein the first beam splitting film layer is disposed on the central optical axis of the beam, wherein:
when the first beam is incident on the first beam splitting film layer, a portion of the first beam is reflected by the first beam splitting film layer, another portion of the first beam passes through the first beam splitting film layer, and
when the second beam is incident on the first beam splitting film layer, the second beam passes through the first beam splitting film layer.

4. The projection apparatus according to claim 3, wherein the first beam is red light, and the second beam is blue light and/or green light.

5. The projection apparatus according to claim 2, wherein the first beam splitting film layer is not disposed on the central optical axis of the beam, wherein:
when the first beam is incident on the first beam splitting film layer, a portion of the first beam is reflected by the first beam splitting film layer, another portion of the first beam passes through the first beam splitting film layer, and
when the second beam is incident on the first beam splitting film layer, the second beam passes through the first beam splitting film layer.

6. The projection apparatus according to claim 5, wherein the first beam is blue light and/or green light, and the second beam is red light.

7. The projection apparatus according to claim 5, wherein the orthographic projection of the first beam splitting film layer on the first reference plane overlaps only with an edge region of the first light spot.

8. The projection apparatus according to claim 1, wherein the projection apparatus further comprises a second beam splitting film layer, wherein:
a transmittance of the second beam splitting film layer in the second wavelength range is less than the transmittance in the first wavelength range, and
light energy of the second beam incident on the second beam splitting film layer that is reflected is less than light energy transmitted through the second beam splitting film layer.

9. The projection apparatus according to claim 8, wherein when the beam is incident on the first beam splitting film layer, a surface perpendicular to the central optical axis of the beam is defined as a first reference plane, the beam forms a first light spot on the first reference plane, an orthographic projection of the first beam splitting film layer on the first reference plane at least partially overlapping with the first light spot, and when the beam is incident on the second beam splitting film layer, a surface perpendicular to the central optical axis of the beam is defined as a second reference plane, the beam forms a second light spot on the second reference plane, an orthographic projection of the second beam splitting film layer on the second reference plane partially overlapping with the second light spot.

10. The projection apparatus according to claim 9, wherein the first beam splitting film layer is disposed on the central optical axis of the beam, and the second beam splitting film layer is not disposed on the central optical axis of the beam, the orthographic projection of the second beam splitting film layer on the second reference plane overlapping only with an edge region of the second light spot.

11. The projection apparatus according to claim 9, wherein the first beam splitting film layer is disposed on a first surface, with a quantity of the first beam splitting film layer is one, and the second beam splitting film layer is disposed on a second surface, with a quantity of the second beam splitting film layer is multiple, the first surface is parallel to the second surface, a third reference plane is defined as parallel to the first surface and the second surface, and the orthographic projections of the multiple second beam splitting film layers on the third reference plane surround the orthographic projection of the first beam splitting film layer on the third reference plane.

12. The projection apparatus according to claim 11, further comprising a transparent substrate, the first beam splitting film layer and the second beam splitting film layer are formed on the transparent substrate, and the transparent substrate is positioned between the illumination module and the light valve module or between the light valve module and the lens module.

13. The projection apparatus according to claim 8, further comprising a first prism and a second prism, wherein:
the first prism comprises a first prism light incident surface and a first prism light exit surface, the first prism light incident surface is adapted to receive the illumination beam, and the illumination beam is guided by the first prism to the first prism light exit surface, the illumination beam is emitted from the first prism light exit surface to the light valve module;
the second prism comprises a second prism light incident surface and a second prism light exit surface, the second prism light incident surface is adapted to receive the image beam from the light valve module, and the image beam is guided by the second prism to the second prism light exit surface, the image beam is emitted from the second prism light exit surface to the lens module; and
the first beam splitting film layer and/or the second beam splitting film layer are/is formed on the first prism light incident surface.

14. The projection apparatus according to claim 8, further comprising a first prism and a second prism, wherein:
the first prism comprises a first prism light incident surface and a first prism light exit surface, the first prism light incident surface is adapted to receive the illumination beam, and the illumination beam is guided by the first prism to the first prism light exit surface, the illumination beam is emitted from the first prism light exit surface to the light valve module;
the second prism comprises a second prism light incident surface and a second prism light exit surface, the second prism light incident surface is adapted to receive the image beam from the light valve module, and the image beam is guided by the second prism to the second prism light exit surface, the image beam is emitted from the second prism light exit surface to the lens module; and
the first beam splitting film layer and/or the second beam splitting film layer are/is formed on the second prism light exit surface.

15. The projection apparatus according to claim 1, wherein the illumination module comprises a light source module and a light homogenization module, wherein:
the light source module is configured to provide a light source beam; and
the light homogenization module is disposed in an optical path of the light source beam, and the light homogenization module is configured to homogenize the light source beam to form the illumination beam.

16. The projection apparatus according to claim 15, further comprising a first prism and a second prism, wherein:
the first prism comprises a first prism light incident surface and a first prism light exit surface, the first prism light incident surface is adapted to receive the illumination beam, and the illumination beam is guided by the first prism to the first prism light exit surface, the illumination beam is emitted from the first prism light exit surface to the light valve module;
the second prism comprises a second prism light incident surface and a second prism light exit surface, the second prism light incident surface is adapted to receive the image beam from the light valve module, and the image beam is guided by the second prism to the second prism light exit surface, the image beam is emitted from the second prism light exit surface to the lens module; and
the first beam splitting film layer is formed on the first prism light incident surface or on the second prism light exit surface.
